(19) United States
(12) Patent Application Publication
(10) Pub. No.: US 2006/0170344 A1
(43) Pub. Date: Aug. 3, 2006

(54) Light emitting device using plasma discharge

(75) Inventors: Young-dong Lee, Gyeonggi-do (KR); Hidekazu Hatanaka, Gyeonggi-do (KR); Seung-hyun Son, Gyeonggi-do (KR); Jai-kwang Shin, Gyeonggi-do (KR); Young-mo Kim, Gyeonggi-do (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SAMSUNG ELECTRONICS CO., LTD., Gyeonggi-do (KR)

(21) Appl. No.: 11/179,727

(22) Filed: Jul. 13, 2005

(30) Foreign Application Priority Data
Feb. 1, 2005 (KR) 10-2005-0009109

(51) Int. Cl. H01J 17/49

(52) U.S. Cl. 313/582

(57) ABSTRACT

A plasma-discharge light emitting device is provided. The plasma-discharge light emitting device may include: rear and front panels separated from each other in a predetermined interval, wherein at least one discharge cell may be provided between the rear and front panels, and wherein plasma discharge may be generated in the discharge cells; a pair of discharge electrodes provided on at least one of the rear and front panels for each of the discharge cells; a trench provided as a portion of each of the discharge cells between the pair of the discharge electrodes; and electron-emitting material layers provided on both sidewalls of the trench.

### CROSS-REFERENCE TO RELATED PATENT APPLICATION

This application claims the benefit of Korean Patent Application No. 10-2005-0009109, filed on Feb. 1, 2005, in the Korean Intellectual Property Office, the disclosure of which is incorporated herein in its entirety by reference

### BACKGROUND OF THE DISCLOSURE

1. Field of the Disclosure

Embodiments of the present disclosure may include a light emitting device using plasma discharge, and more particularly, a light emitting device using plasma discharge capable of reducing discharge voltage and improving luminous efficiency.

2. Description of the Related Art

In a light emitting device using plasma discharge (hereinafter, referred to as a plasma-discharge light emitting device), the plasma discharge is generated by a direct-current (DC) or alternating-current (AC) voltage applied between two electrodes, ultraviolet (UV) light generated during the discharge process excites fluorescent materials, and an image is formed by using visible light emitting from the fluorescence materials. Among the plasma-discharge light emitting devices, there are plasma display panel (PDP) and a flat lamp which is used for a black-light of a liquid crystal display (LCD).

The plasma-discharge light emitting device is classified into DC and AC types. In the DC type light emitting device, all electrodes are exposed to a discharge space, and discharge is generated by electrical charges directly moving between electrodes. In the AC type light emitting device, at least one electrode is covered with a dielectric layer, and discharge is generated by wall charges instead of the electrical charges directly moving between the electrodes.

In addition, the plasma-discharge light emitting device is classified into facing and surface discharge types. In the facing discharge light emitting device, a pair of two sustaining electrodes provided on front and rear substrates, facing each other, and discharge is generated in a direction perpendicular to the substrates. In the surface discharge light emitting device, a pair of sustaining electrodes is provided on the same substrate, and discharge is generated in a direction parallel to the substrate.

Although it has high luminous efficiency, the facing discharge light emitting device has a disadvantage that its fluorescent layer can be easily deteriorated due to plasma. Therefore, the surface discharge light emitting device has been mainly used.

FIGS. 1 and 2 illustrate a conventional surface discharge plasma display panel. In FIG. 2, only the front substrate is illustrated in a 90°-rotated state in order to clearly show an internal structure of the plasma display panel.

Referring to FIGS. 1 and 2, the conventional plasma display panel includes rear and front substrates 10 and 20 facing each other. The space between the rear and front substrates 10 and 20 is a discharge space where the plasma discharge is generated.

A plurality of address electrodes 11 are provided on an upper surface of the rear substrate 10. The address electrodes 11 are buried in a first dielectric layer 12. A plurality of barrier ribs 13 partitioning the discharge space are provided on an upper of the first dielectric layer 12 to partition the discharge space. In addition, the barrier ribs 13 are provided in a predetermined interval on the upper surface of the first dielectric layer 12 in order to prevent electrical or optical crosstalk between the discharge cells 14. The discharge cells 14 are filled with a discharge gas which is generally a mixture of Ne and Xe. Fluorescent layers having a predetermined thickness are coated on inner walls of the discharge cells 14, that is, the upper surface of the first dielectric layer 12 and side surfaces of the barrier ribs 13.

The front substrate 20 is a transparent substrate, which is mainly made of glass capable of passing visible light. The front substrate 20 is coupled with the rear substrate 10 provided with the barrier ribs 13. On a lower surface of the front substrate 20, there are provided pairs of sustain electrodes 21a and 21b in a direction perpendicular to the address electrodes 11. The sustain electrodes 21a and 21b are mainly made of a transparent, conductive material such as indium tin oxide (ITO) capable of passing the visible light. On lower surfaces of the sustain electrodes 21a and 21b, there are provided bus electrodes 22a and 22b, made of metal, having a narrower width than those of the sustain electrodes 12a and 12b in order to reduce line resistance thereof. The sustain electrodes 21a and 21b and bus electrodes 22a and 22b are buried in a second dielectric layer 23, which is a transparent layer. A protective layer 24 is provided on a lower surface of the second dielectric layer 23. The protective layer 24 functions as preventing damage to the second dielectric layer 23 due to sputtered plasma particles and reducing discharge voltage by emitting secondary electrons. In general, the protective layer 24 is made of MgO.

In the plasma display panel, the luminous efficiency can be improved by increasing a Xe partial pressure. However, in this case, there is a problem of increase in the discharge voltage. In addition, the luminous efficiency can be improved by widening a distance between the sustaining electrodes 21a and 21b to elongate a discharge path. However, in this case, there is a problem of increase in the discharge voltage.

### SUMMARY OF THE DISCLOSURE

Embodiments of the present disclosure may provide a plasma-discharge light emitting device capable of reducing discharge voltage and improving luminous efficiency.

According to an aspect of the present disclosure, there may be provided a plasma-discharge light emitting device comprising: rear and front panels separated from each other in a predetermined interval, wherein at least one discharge cell may be provided between the rear and front panels, and wherein plasma discharge may be generated in the discharge cells; a pair of discharge electrodes provided on at least one of the rear and front panels for each of the discharge cells; a trench provided as a portion of each of the discharge cells between the pair of the discharge electrodes; and an electron-emitting material layer provided on a sidewall of the trench.

In the aspect of the present disclosure, the electron-emitting material layer may be made of OPPS (oxidized porous polysilicon). In addition, the plasma-discharge light emitting device may further comprise a grid electrode provided on the electron-emitting material layer.

In addition, the electron-emitting material layer may be made of CNT (carbon nanotube).

According to another aspect of the present disclosure, there may be provided a plasma display panel comprising: rear and front substrate separated from each other in a predetermined interval, wherein a plurality of discharge cells may be provided between the rear and front substrates, and wherein plasma discharge may be generated in the discharge cells; a plurality of barrier ribs provided between the rear and front substrates to partition a space between the rear and front substrates and define the discharge cells; a plurality of address electrodes provided on an upper surface of the rear substrate; a first dielectric layer provided on the upper surface of the rear substrate to bury the address electrodes; a pair of sustain electrodes provided on a lower surface of the front substrate for each of the discharge cells; a second dielectric layer provided on the lower surface of the front substrate to bury the sustain electrode, wherein a trench may be provided as a portion of each of the discharge cells between the pair of the sustain electrodes; electron-emitting material layers provided on both sidewalls of the trench; and a fluorescent layer formed on an inner wall of each of the discharge cells.

According to still another aspect of the present disclosure, there may be provided a flat lamp comprising: rear and front substrate separated from each other in a predetermined interval, wherein at least one discharge cell may be provided between the rear and front substrates, and wherein plasma discharge may be generated in the discharge cells; a pair of discharge electrodes provided on an inner surface of at least one of the rear and front substrates for each of the discharge cells; a dielectric layer provided on the inner surface of each of the substrates where the discharge electrodes are provided, wherein the dielectric layer buries the discharge electrodes, wherein a trench may be provided as a portion of each of each of the discharge cells between the pair of the discharge electrodes; electron-emitting material layers provided on both of sidewalls of the trench; and a fluorescent layer formed on an inner wall of each of the discharge cells. In the aspect of the present disclosure, the flat lamp may further comprise at least one spacer, wherein the spacers partition a space between the rear and front substrates to define the discharge cells.

According to further still another aspect of the present disclosure, there may be provided flat lamp comprising: rear and front substrate separated from each other in a predetermined interval, wherein at least one discharge cell may be provided between the rear and front substrates, and wherein plasma discharge may be generated in the discharge cells; a pair of discharge electrodes provided on an outer surface of at least one of the rear and front substrates for each of the discharge cells; a trench provided as a portion of each of the discharge cells on an inner portion of the substrate between the pair of the discharge electrodes; electron-emitting material layers provided on both of sidewalls of the trench; and a fluorescent layer formed on an inner wall of each of the discharge cells.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating a conventional surface discharge plasma display panel;

FIG. 2 is a cross sectional view of the conventional surface discharge plasma display panel of FIG. 1;

FIG. 3 is a cross sectional view of a plasma display panel according to a first embodiment of the present disclosure;

FIG. 4 shows an electric field formed in a trench in the plasma display panel of FIG. 3 and an acceleration direction of electrons under the electric field;

FIG. 5 is a cross sectional view of a modified example of the plasma display panel according to the first embodiment of the present disclosure;

FIG. 6 is a cross sectional view of a plasma display panel according to a second embodiment of the present disclosure;

FIG. 7 is a cross sectional view of a plasma display panel according to a third embodiment of the present disclosure;

FIG. 8 shows an electric field formed in a trench in the plasma display panel of FIG. 7 and an acceleration direction of electrons under the electric field;

FIG. 9 is a cross sectional view of a flat lamp according to a fourth embodiment of the present disclosure;

FIG. 10 is a cross sectional view of a flat lamp according to an modified example of the fourth embodiment of the present disclosure;

FIG. 11 is a cross sectional view of a flat lamp according to a fifth embodiment of the present disclosure;

FIG. 12 is a cross sectional view of a flat lamp according to a sixth embodiment of the present disclosure;

FIG. 13 is a cross sectional view of a flat lamp according to a seventh embodiment of the present disclosure;

FIG. 14 is a cross sectional view of a flat lamp according to an eighth embodiment of the present disclosure; and

FIG. 15 is a cross sectional view of a flat lamp according to a ninth embodiment of the present disclosure.

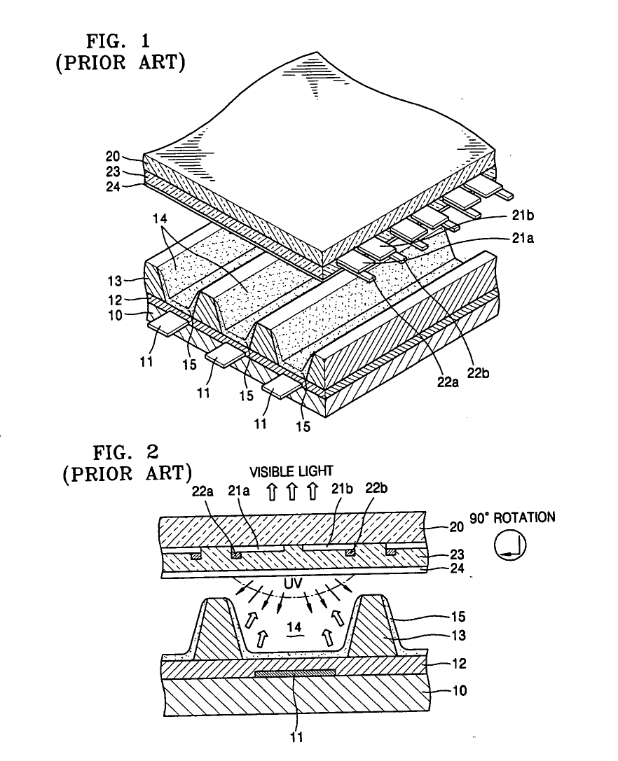

### DETAILED DESCRIPTION OF EXEMPLARY EMBODIMENTS OF THE DISCLOSURE

Now, the preferred embodiments of the present disclosure will be described in detail with reference to the accompanying drawings.

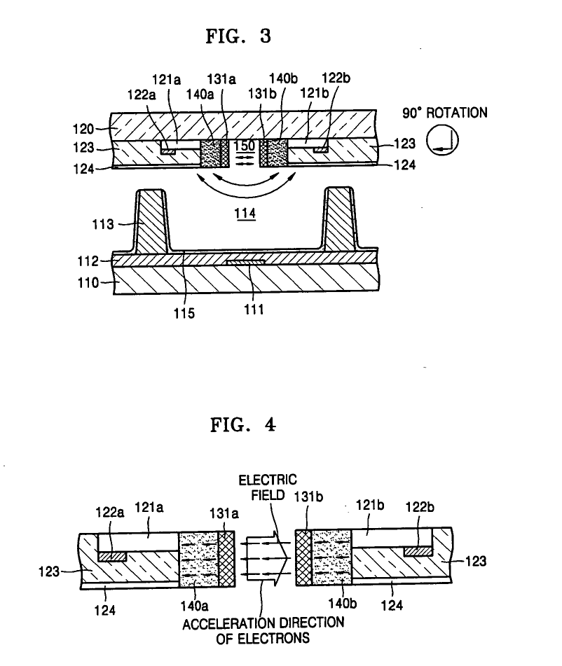

A plasma-discharge light emitting device according to the present disclosure may include a plasma display panel and a flat lamp. Firstly, embodiments of the plasma display panel according to the present disclosure will be described. In FIGS. 3, 5, 6 and 7, only the front substrate is illustrated in a 90°-rotated state in order to clearly show an internal structure of the plasma display panel.

FIG. 3 is a cross sectional view of a plasma display panel according to a first embodiment of the present disclosure. The plasma display panel may include rear and front panels separated from each other in a predetermined interval. A plurality of barrier ribs 113 may be provided between the rear and front panels. The barrier ribs 113 partition a space between rear and front panels to form a plurality of discharge cells 114 where plasma discharge may be generated. In addition, the barrier ribs 113 prevent electrical and optical crosstalk between adjacent discharge cells 114. The discharge cells 114 may be filled with a discharge gas emitting ultraviolet (UV) light at the plasma discharge. The discharge gas may be generally a mixture of Ne and Xe. Red (R), green (G) and blue (B) fluorescent layers 115 having a predetermined thickness may be coated on inner walls of the respective discharge cells 114. The UV light generated by the discharge may excite the fluorescent layers 115. In turn, the fluorescent layers 115 may emit visible light in respective colors.

The rear panel may include a rear substrate 110, a plurality of address electrodes 111 formed on an upper surface of the rear substrate 110, and a first dielectric layer 112 formed on the upper surface of the rear substrate 110 to bury the address electrodes 111. In general, the rear substrate 110 may be a glass substrate. The address electrodes 111 formed on the upper surface of the rear substrate 110 may be parallel to each other. The address electrode 111 is buried by the first dielectric layer 112.

The barrier ribs 113 provided on an upper surface of the first dielectric layer 112 may be parallel to the address electrodes 111 and separated from each other in a predetermined interval. The fluorescent layers 115 having a predetermined thickness may be provided on the upper surface of the first dielectric layer 112 and the sidewalls of the barrier ribs 113.

The front panel may include a front substrate 120 separated from the rear substrate 110 in a predetermined interval, a plurality of pairs of first and second sustain electrodes 121a and 121b provided for the respective discharge cells 114 on a lower surface of the front substrate 120, and a second dielectric layer 123 provided on the lower surface of the front substrate 120 to bury the first and second sustain electrodes 121a and 121b.

In general, the front substrate 120 may be a glass substrate capable of passing visible light. On the lower surface of the front substrate 120, there may be provided pairs of the first and second sustain electrodes 121a and 121b for the respective discharge cells 114 in a direction intersecting the address electrodes 111. Here, the first and second sustain electrodes 121a and 121b may be mainly made of a transparent conductive material such as indium tin oxide (ITO). On a lower surface of the first and second sustain electrodes 121a and 121b, there may be provided bus electrodes 122a and 122b in order to reduce line resistance of the first and second sustain electrodes 121a and 121b. The bus electrodes 122a and 122b having a narrower width than the first and second sustain electrodes 121a and 121b may be provided along edge portions of the first and second sustain electrodes 121a and 121b. Here, the bus electrodes 122a and 122b may be preferably made of a metallic material such as Al and Ag. The first and second sustain electrodes 121a and 121b and the bus electrodes 122a and 122b may be buried with the second dielectric layer 123, which is made of a transparent material.

A trench 150 having a predetermined width may be provided on the second dielectric layer 123 between the first and second sustain electrodes 121a and 121b. The trench 150 may be formed as a portion of each of the discharge cells 114. The trench 150 may be parallel to the first and second sustain electrodes 121a and 121b. Since the trench 150 may be provided on the second dielectric layer 123 between the first and second sustain electrodes 121a and 121b, an electric field may be effectively concentrated on an inner portion of the trench 150, so that the discharge voltage can be reduced.

On the other hand, first and second electron-emitting material layers 140a and 140b having a predetermined thickness may be provided on the respective sidewalls of the trench 150. Preferably, the first and second electron-emitting material layers 140a and 140b may be made of oxidized porous polysilicon (OPPS) capable of accelerating and emitting electrons outwardly. In addition, first and second grid electrodes 131a and 131b may be provided on the respective first and second electron-emitting material layers 140a and 140b. The first grid electrode 131a may be an electrode for accelerating electrons in the first electron-emitting material layer 140a toward the trench 150 by using a voltage difference between the first grid electrode 131a and the first sustain electrode 121a. The second grid electrode 131b may be an electrode for accelerating electrons in the second electron-emitting material layer 140b toward the trench 15 by using a voltage difference between the second sustain electrode 121b and the second grid electrode 131b.

A protective layer 124 made of MgO may be provided on a lower surface of the second dielectric layer 123. The protective layer 124 may have a function of preventing damage to the second dielectric layer 123 due to sputtering of plasma particles. In addition, the protective layer 124 may have a function of reducing a discharge voltage by emitting secondary electrons.

In the plasma display panel, an AC voltage may be applied between the first and second sustain electrodes 121a and 121b to generate the plasma discharge in the discharge cells 114.

Referring to FIG. 4, in the plasma display panel according to the embodiment, when a predetermined first voltage may be applied between the first and second sustain electrodes 121a and 121b, the first and second sustain electrodes 121a and 121b serve as cathode and anode electrodes, respectively. FIG. 4 shows an electric field formed in the trench 150 and an acceleration direction of the electrons under the electric field. The strong electric field may be generated in the trench 150 in the direction from the second sustain electrode 121b to the first sustain electrode 121a. Due to the strong electric field, the discharge may be primarily generated in the trench 150, and after that, the discharge spreads over the entire region of the discharge cell 114. The electrons accelerated from the first electron-emitting material layer 140a may be emitted and accelerated into the strong electric field of the trench 150 toward the second sustain electrode 121b. Here, a predetermined voltage may be applied to the first grid electrode 131a, so that the electrons can be emitted and accelerated from the first electron-emitting material layer 140a due to the voltage difference between the first grid electrode 131a and the first sustain electrode 121a.

Next, when a predetermined second voltage is applied between the first and second sustain electrodes 121a and 121b, the first and second sustain electrodes 121a and 121b may serve as anode and cathode electrodes, respectively. A strong electric field may be generated in the trench 150 in the direction from the first sustain electrode 121a to the second sustain electrode 121b, so that the discharge may be generated in the trench 150. The electrons accelerated from the second electron-emitting material layer 140b may be emitted into the strong electric field of the trench 150 toward the first sustain electrode 121a. Here, a predetermined voltage may be applied to the second grid electrode 131b, so that the electrons may be emitted and accelerated from the second electron-emitting material layer 140b due to the voltage difference between the second grid electrode 131b and the second sustain electrode 121b.

Like this, in the plasma display panel, when a predetermined AC voltage is applied between the first and second sustain electrodes 121a and 121b, the discharge may be primarily generated in the trench 150, and after that, the discharge may spread over the entire regions of the discharge cell 114. Due to the strong electric field generated in the trench 150, the discharge may be generated by using a low voltage. Therefore, it is possible to reduce a discharge voltage. In addition, due to predetermined voltages applied to the first and second grid electrodes 131a and 131b, the electrons accelerated from the first and second-electron-emitting material layers 140a and 140b may be alternately emitted into the strong electric field of the trench 150. As a result, the plasma discharge can be efficiently generated by the emitted electrons, so that it is possible to improve brightness and luminous efficiency.

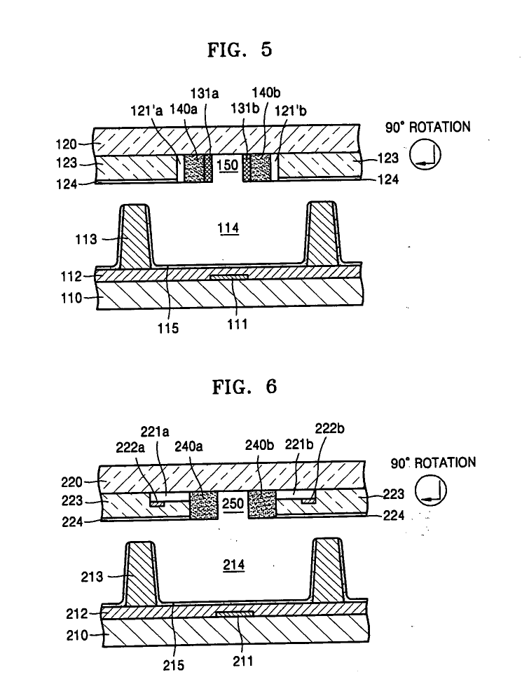

FIG. 5 shows a modified example of the plasma display panel according to the first embodiment of the present invention. In the modified example, first and second sustain electrodes 121a′ and 121b′ may be provided facing to the first and second grid electrodes 131a and 131b, respectively.

FIG. 6 is a cross sectional view of a plasma display panel according to a second embodiment of the present invention. The plasma display panel may include rear and front panels separated from each other in a predetermined interval. A plurality of barrier ribs 213 defining discharge cells 114 may be provided between the rear and front panels. The discharge cells 214 may be filled with a discharge gas emitting UV light. Fluorescent layers 215 having a predetermined thickness may be coated on inner walls of the respective discharge cells 214.

The rear panel may include a rear substrate 210, a plurality of address electrodes 211 formed on an upper surface of the rear substrate 210, and a first dielectric layer 212 formed on the upper surface of the rear substrate 210 to bury the address electrodes 211.

The front panel may include a front substrate 220 separated from the rear substrate 210 in a predetermined interval, a plurality of pairs of first and second sustain electrodes 221a and 221b provided for the respective discharge cells 214 on a lower surface of the front substrate 220, and a second dielectric layer 223 provided on the lower surface of the front substrate 220 to bury the first and second sustain electrodes 221a and 221b. On a lower surface of the first and second sustain electrodes 221a and 221b, there may be provided bus electrodes 222a and 222b. The first and second sustain electrodes 221a and 221b and the bus electrodes 222a and 222b may be buried with the second dielectric layer 223, which may be made of a transparent material.

A trench 250 may be provided on the second dielectric layer 223 between the first and second sustain electrodes 221a and 221b. As described above, due to the trench 250, an electric field may be effectively concentrated on an inner portion of the trench 250, so that the discharge voltage may be reduced.

First and second electron-emitting material layers 240a and 240b having a predetermined thickness may be provided on the respective sidewalls of the trench 250. The first and second electron-emitting material layers 240a and 240b may be made of oxidized porous polysilicon (OPPS) capable of accelerating and emitting electrons outwardly. A protective layer 224 made of MgO may be provided on a lower surface of the second electric layer 223.

Like this, in the plasma display panel, when a predetermined AC voltage is applied between the first and second sustain electrodes 221a and 221b, the discharge is primarily generated in the trench 250, and after that, the discharge may spread over the entire regions of the discharge cell 214. Due to the AC voltage applied between the first and second sustain electrodes 221a and 221b, the electrons accelerated from the first and second electron-emitting material layers 240a and 240b may be alternately emitted into the strong electric field of the trench 250.

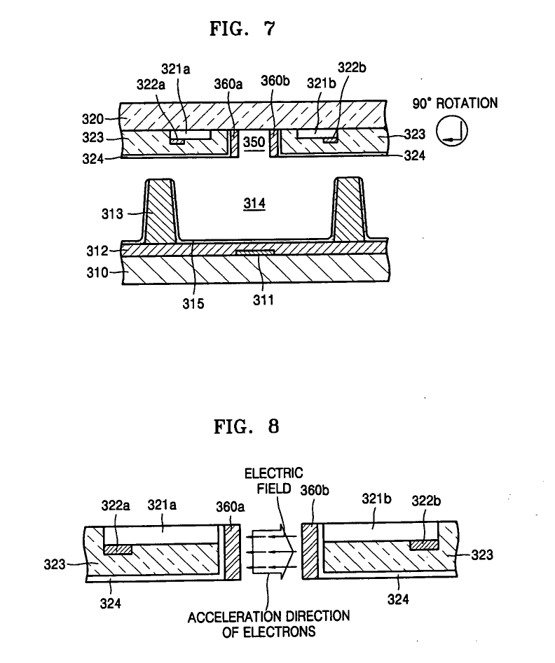

FIG. 7 is a cross sectional view of a plasma display panel according to a third embodiment of the present disclosure. The plasma display panel may include rear and front panels separated from each other in a predetermined interval. A plurality of barrier ribs 313 defining discharge cells 314 may be provided between the rear and front panels. The discharge cells 314 may be filled with a discharge gas emitting UV light. Fluorescent layers 315 having a predetermined thickness may be coated on inner walls of the respective discharge cells 314. The rear panel may include a rear substrate 310, a plurality of address electrodes 311 formed on an upper surface of the rear substrate 310, and a first dielectric layer 312 formed on the upper surface of the rear substrate 310 to bury the address electrodes 311. The front panel may include a front substrate 320 separated from the rear substrate 310 in a predetermined interval, a plurality of pairs of first and second sustain electrodes 321a and 321b provided for the respective discharge cells 314 on a lower surface of the front substrate 320, and a second dielectric layer 323 provided on the lower surface of the front substrate 320 to bury the first and second sustain electrodes 321a and 321b. On a lower surface of the first and second sustain electrodes 321a and 321b, there may be provided bus electrodes 322a and 322b. The first and second sustain electrodes 321a and 321b and the bus electrodes 322a and 322b may be buried with the second dielectric layer 323, which may be made of a transparent material.

A trench 350 may be provided on the second dielectric layer 323 between the first and second sustain electrodes 321a and 321b. First and second electron-emitting material layers 340a and 340b may be provided on the respective sidewalls of the trench 350. Preferably, the first and second electron-emitting material layers 340a and 340b may be made of carbon nanotube (CNT) capable of emitting a large number of electrons into the trench 350. A protective layer 324 made of MgO may be provided on a lower surface of the second electric layer 323.

Referring to FIG. 8, in the plasma display panel according to the embodiment, when a predetermined first voltage is applied between the first and second sustain electrodes 321a and 321b, the first and second sustain electrodes 321a and 321b may serve as cathode and anode electrodes, respectively. FIG. 8 shows an electric field formed in the trench 350 and an acceleration direction of the electrons under the electric field. The strong electric field may be generated in the trench 350 in the direction from the second sustain electrode 321b to the first sustain electrode 321a. Due to the strong electric field, the discharge may be primarily generated in the trench 350, and after that, the discharge spreads over the entire region of the discharge cell 314. A large number of the electrons emitted from the first electron-emitting material layer 340a may be accelerated into the strong electric field of the trench 350 toward the second sustain electrode 321b.

Next, when a predetermined second voltage is applied between the first and second sustain electrodes 321a and 321b, the first and second sustain electrodes 321a and 321b may serve as anode and cathode electrodes, respectively. A strong electric field may be generated in the trench 350 in the direction from the first sustain electrode 321a to the second sustain electrode 321b, so that the discharge may be generated in the trench 350. A large number of the electrons emitted from the second electron-emitting material layer 340b may be accelerated into the strong electric field of the trench 350 toward the first sustain electrode 321a.

Like this, in the plasma display panel, when a predetermined AC voltage is applied between the first and second sustain electrodes 321a and 321b, the discharge may be primarily generated in the trench 350, and after that, the discharge may spread over the entire regions of the discharge cell 314. Due to the strong electric field generated in the trench 350, the discharge may be generated by using a low voltage. Therefore, it may be possible to reduce a discharge voltage. In addition, due to the predetermined AC voltages applied between the first and second sustain electrodes 321a and 321b, a large number of the electrons emitted from the first and second electron-emitting material layers 340a and 340b may be alternately accelerated into the strong electric field of the trench 350. As a result, the plasma discharge may be efficiently generated by the accelerated electrons, so that it may be possible to improve brightness and luminous efficiency.

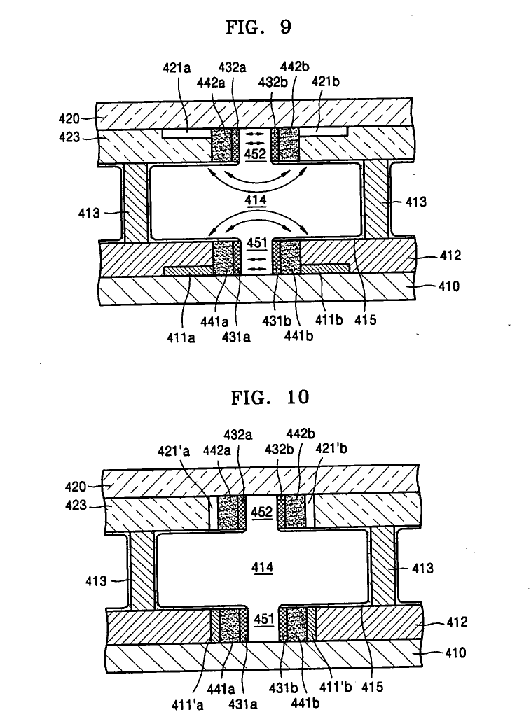

Now, a flat lamp according to an embodiment of the present disclosure will be described. FIG. 9 is a cross sectional view of a flat lamp according to the fourth embodiment of the present disclosure. The flat lamp may include rear and front panels separated from each other in a predetermined interval. Between the rear and front panels, there may be provided at least one discharge cell 414 where plasma discharge may be generated. In addition, between the rear and front panels, there may be provided at least one spacer 413 which supports the rear and front panels and partitions the space between the rear and front panels to define the discharge cells 414. The discharge cells 414 may be filled with a discharge gas emitting ultraviolet (UV) light at the plasma discharge. Fluorescent layers 415 having a predetermined thickness may be coated on inner walls of the respective discharge cells 414.

The rear panel includes a rear substrate 410, a plurality of pairs of first and second discharge electrodes 411a and 411b formed for the respective discharge cells 414 on an upper surface of the rear substrate 410, and a first dielectric layer 412 formed on the upper surface of the rear substrate 410 to bury the first and second discharge electrodes 411a and 411b. A first trench 451 may be provided on the first dielectric layer 412 between the first and second discharge electrodes 411a and 411b. The first trench 451 may be formed as a portion of each of the discharge cells 414. The first trench 451 may be parallel to the first and second discharge electrodes 411a and 411b.

First and second electron-emitting material layers 441a. and 441b may be provided on the respective sidewalls of the first trench 451. Preferably, the first and second electron-emitting material layers 441a and 441b may be made of OPPS capable of accelerating and emitting electrons outwardly. In addition, first and second grid electrodes 431a and 431b may be provided on the respective first and second electron-emitting material layers 441a and 441b. The first grid electrode 431a may be an electrode for accelerating electrons in the first electron-emitting material layer 441a toward the first trench 451 by using a voltage difference between the first grid electrode 431a and the first discharge electrode 411a. The second grid 411b may be an electrode for accelerating electrons in the second electron-emitting material layer 441b toward the first trench 451 by using a voltage difference between the second grid electrode 431b and the second discharge electrode 411b. The front panel may include a front substrate 420 separated from the rear substrate 410 in a predetermined interval, a plurality of pairs of third and fourth discharge electrodes 421a and 421b formed for the respective discharge cells 414 on a lower surface of the front substrate 420, and a second dielectric layer 423 formed on the lower surface of the front substrate 420 to bury the third and fourth discharge electrodes 421a and 421b. A second trench 452 may be provided on the second dielectric layer 423 between the third and fourth discharge electrodes 421a and 421b. The second trench 452 may be formed as a portion of each of the discharge cells 414. The second trench 452 may be parallel to the third and fourth discharge electrodes 421a and 421b.

Third and fourth electron-emitting material layers 442a and 442b may be provided on the respective sidewalls of the second trench 452. Preferably, the third and fourth electron-emitting material layers 442a and 442b may be made of OPPS capable of accelerating and emitting electrons outwardly. In addition, third and fourth grid electrodes 432a and 432b may be provided on the respective third and fourth electron-emitting material layers 442a and 442b. The third grid electrode 432a may be an electrode for accelerating electrons in the third electron-emitting material layer 442a toward the second trench 452 by using a voltage difference between the third grid electrode 432a and the third discharge electrode 421a. The fourth grid electrode 421b may be an electrode for accelerating electrons in the fourth electron-emitting material layer 442b toward the second trench 452 by using a voltage difference between the fourth grid electrode 421b and the fourth discharge electrode 421b.

In the flat lamp according to the embodiment, when predetermined AC voltages are applied between the first and second discharge electrodes 411a and 411b and between the third and fourth discharge electrodes 421a and 421b, the discharge may be primarily generated in the first and second trenches 451 and 452, and after that, the discharge may spread over the entire region of the discharge cell 414. Due to a strong electric field generated in the first and second trenches 451 and 452, the discharge may be generated by using a low voltage. Therefore, it is possible to reduce a discharge voltage. In addition, due to predetermined voltages applied to the first and second grid electrodes 431a and 431b, the electrons accelerated from the first and second electron-emitting material layers 441a and 441b may be alternately emitted into the strong electric field of the first trench 451. In addition, due to predetermined voltages applied to the third and fourth grid electrodes 432a and 432b, the electrons accelerated from the third and fourth electron-emitting material layers 442a and 442b may be alternately emitted into the strong electric field of the second trench 452. As a result, the plasma discharge may be efficiently generated by the emitted electrons, so that it is possible to improve brightness and luminous efficiency.

FIG. 10 shows a modified example of the flat lamp according to the fourth embodiment. In the modified example, first and second discharge electrodes 411a′ and 411b′ may be provided facing the first and second grid electrodes 431a and 431b, respectively; and third and fourth discharge electrodes 421a′ and 421b′ may be provided facing the third and fourth grid electrodes 432a and 432b.

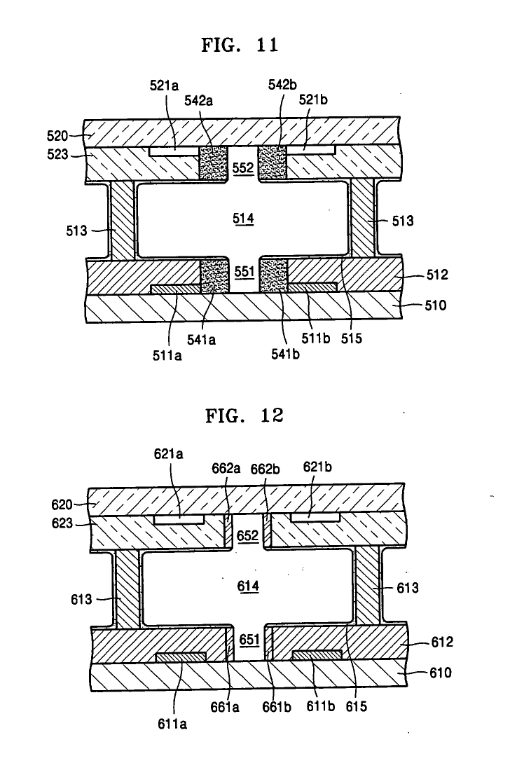

FIG. 11 is a cross sectional view of a flat lamp according to a fifth embodiment of the present invention. The flat lamp may include rear and front panels separated from each other in a predetermined interval. Between the rear and front panels, there/may be provided at least one discharge cell 514 where plasma discharge may be generated. In addition, between the rear and front panels, there may be provided at least one spacer 513 which supports the rear and front panels and partitions the space between the rear and front panels to define the discharge cells 514. The discharge cells 514 may be filled with a discharge gas emitting UV light at the plasma discharge. Fluorescent layers 515 having a predetermined thickness may be coated on inner walls of the respective discharge cells 514.

The rear panel may include a rear substrate 510, a plurality of pairs of first and second discharge electrodes 511a and 511b formed for the respective discharge cells 514 on an upper surface of the rear substrate 510, and a first dielectric layer 512 formed on the upper surface of the rear substrate 510 to bury the first and second discharge electrodes 511a and 511b. A first trench 551 may be provided on the first dielectric layer 512 between the first and second discharge electrodes 511a and 511b. First and second electron-emitting material layers 541a and 541b may be provided on the respective sidewalls of the first trench 551. Preferably, the first and second electron-emitting material layers 541a and 541b may be made of OPPS.

The front panel includes a front substrate 520 separated from the rear substrate 510 in a predetermined interval, a plurality of pairs of third and fourth discharge electrodes 521a and 521b formed for the respective discharge cells 514 on a lower surface of the front substrate 520, and a second dielectric layer 523 formed on the lower surface of the front substrate 520 to bury the third and fourth discharge electrodes 521a and 521b. A second trench 552 may be provided on the second dielectric layer 523 between the third and fourth discharge electrodes 521a and 521b. Third and fourth electron-emitting material layers 542a and 542b may be provided on the respective sidewalls of the second trench 552. Preferably, the third and fourth electron-emitting material layers 542a and 542b may be made of OPPS.

In the flat lamp according to the embodiment, when predetermined AC voltages are applied between the first and second discharge electrodes 511a and 511b and between the third and fourth discharge electrodes 521a and 521b, the discharge may be primarily generated in the first and second trenches 551 and 552, and after that, the discharge may spread over the entire region of the discharge cell 514. Due to predetermined voltages applied to the first and second grid electrodes 531a and 531b, the electrons accelerated from the first and second electron-emitting material layers 541a and 541b may be alternately emitted into the strong electric field of the first trench 551. In addition, due to predetermined voltages applied to the third and fourth grid electrodes 532a and 532b, the electrons accelerated from the third and fourth electron-emitting material layers 542a and 542b may be alternately emitted into the strong electric field of the second trench 552. As a result, the plasma discharge may be efficiently generated by the emitted electrons, so that it may be possible to improve brightness and luminous efficiency.

FIG. 12 is a cross sectional view of a flat lamp according to a sixth embodiment of the present invention. The flat lamp includes rear and front panels separated from each other in a predetermined interval. Between the rear and front panels, there may be provided at least one discharge cell 614 where plasma discharge may be generated. In addition, between the rear and front panels, there may be provided at least one spacer 613 which supports the rear and front panels and partitions the space between the rear and front panels to define the discharge cells 614. The discharge cells 614 may be filled with a discharge gas emitting UV light at the plasma discharge. Fluorescent layers 615 having a predetermined thickness may be coated on inner walls of the respective discharge cells 614.

The rear panel may include a rear substrate 610, a plurality of pairs of first and second discharge electrodes 611a and 611b formed for the respective discharge cells 614 on an upper surface of the rear substrate 610, and a first dielectric layer 612 formed on the upper surface of the rear substrate 610 to bury the first and second discharge electrodes 611a and 611b. A first trench 651 may be provided on the first dielectric layer 612 between the first and second discharge electrodes 611a and 611b. First and second electron-emitting material layers 641a and 641b may be provided on the respective sidewalls of the first trench 651. Preferably, the first and second electron-emitting material layers 641a and 641b may be made of CNT capable of emitting a large number of electrons into the first trench 651.

The front panel includes a front substrate 620 separated from the rear substrate 610 in a predetermined interval, a plurality of pairs of third and fourth discharge electrodes 621a and 621b formed for the respective discharge cells 614 on a lower surface of the front substrate 620, and a second dielectric layer 623 formed on the lower surface of the front substrate 620 to bury the third and fourth discharge electrodes 621a and 621b. A second trench 652 may be provided on the second dielectric layer 623 between the third and fourth discharge electrodes 621a and 621b. Third and fourth electron-emitting material layers 642a and 642b may be provided on the respective sidewalls of the second trench 652. Preferably, the third and fourth electron-emitting material layers 642a and 642b may be made of CNT capable of emitting a large number of electrons into the second trench 652.

In the flat lamp according to the embodiment, when predetermined AC voltages are applied between the first and second discharge electrodes 611a and 611b and between the third and fourth discharge electrodes 621a and 621b, the discharge may be primarily generated in the first and second trenches 651 and 652, and after that, the discharge may spread over the entire region of the discharge cell 614. Due to the predetermined AC voltages applied between the first and second discharge electrodes 611a and 611b, a large number of the electrons emitted from the first and second electron-emitting material layers 641a and 641b may be alternately accelerated into the strong electric field of the first trench 651. In addition, due to the predetermined AC voltages applied the third and fourth discharge electrodes 621a and 621b, a large number of the electrons accelerated from the third and fourth electron-emitting material layers 642a and 642b can be alternately accelerated into the strong electric field of the second trench 652. As a result, the plasma discharge may be efficiently generated by the accelerated electrons, so that it is possible to improve brightness and luminous efficiency.

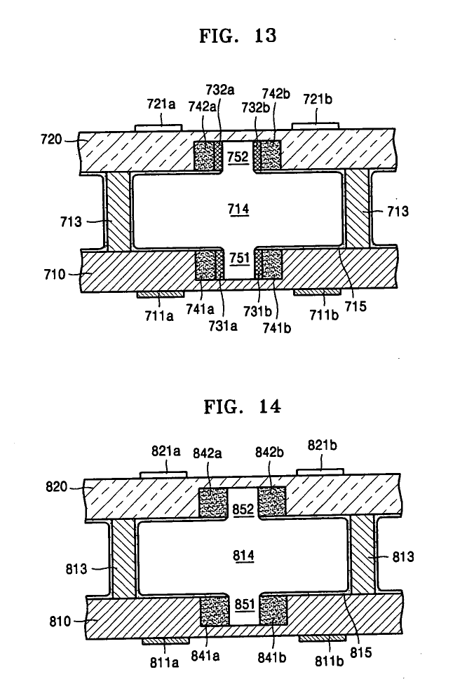

FIG. 13 is a cross sectional view of a flat lamp according to a seventh embodiment of the present disclosure. The flat lamp may include rear and front panels separated from each other in a predetermined interval. Between the rear and front panels, there may be provided at least one discharge cell 714 where plasma discharge may be generated. In addition, between the rear and front panels, there may be provided at least one spacer 713 which supports the rear and front panels and partitions the space between the rear and front panels to define the discharge cells 714. The discharge cells 714 may be filled with a discharge gas emitting ultraviolet (UV) light at the plasma discharge. Fluorescent layers 715 having a predetermined thickness may be coated on inner walls of the respective discharge cells 714.

The rear panel may include a rear substrate 710 and a plurality of pairs of first and second discharge electrodes 711a and 711b formed for the respective discharge cells 714 on a lower surface of the rear substrate 710. A first trench 751 having a predetermined depth may be provided on an upper portion of the rear substrate 710 between first and second discharge electrodes 711a and 711b. The first trench 751 may be formed as a portion of each of the discharge cells 714. The first trench 751 may be parallel to the first and second discharge electrodes 711a and 711b.

First and second electron-emitting material layers 741a and 741b having a predetermined thickness may be provided on the respective sidewalls of the first trench 751. Preferably, the first and second electron-emitting material layers 741a and 741b may be made of OPPS capable of accelerating and emitting electrons outwardly. In addition, first and second grid electrodes 731a and 731b may be provided on the respective first and second electron-emitting material layers 741a and 741b. The first grid electrode 731a may be an electrode for accelerating electrons in the first electron-emitting material layer 741a toward the first trench 751 by using a voltage difference between the first grid electrode 731a and the first discharge electrode 711a. The second grid 711b may be an electrode for accelerating electrons in the second electron-emitting material layer 741b toward the first trench 751 by using a voltage difference between the second grid electrode 731b and the second discharge electrode 711b.

The front panel includes a front substrate 720 separated from the rear substrate 710 in a predetermined interval and a plurality of pairs of third and fourth discharge electrodes 721a and 721b formed for the respective discharge cells 714 on an upper surface of the front substrate 720. A second trench 752 having a predetermined depth may be provided on a lower portion of the front substrate 720 between the third and fourth discharge electrodes 721a and 721b. The second trench 752 may be formed as a portion of each of the discharge cells 714. The second trench 752 may be parallel to the third and fourth discharge electrodes 721a and 721b.

Third and fourth electron-emitting material layers 742a and 742b having a predetermined thickness may be provided on the respective sidewalls of the second trench 752. Preferably, the third and fourth electron-emitting material layers 742a and 742b are made of OPPS capable of accelerating and emitting electrons outwardly. In addition, third and fourth grid electrodes 732a and 732b may be provided on the respective third and fourth electron-emitting material layers 742a and 742b. The third grid electrode 732a may be an electrode for accelerating electrons in the third electron-emitting material layer 742a toward the second trench 752 by using a voltage difference between the third grid electrode 732a and the third discharge electrode 721a. The fourth grid electrode 721b may be an electrode for accelerating electrons in the fourth electron-emitting material layer 742b toward the second trench 752 by using a voltage difference between the fourth grid electrode 721b and the fourth discharge electrode 721b.

In the flat lamp according to the embodiment, when predetermined AC voltages are applied between the first and second discharge electrodes 711a and 711b and between the third and fourth discharge electrodes 721a and 721b, the discharge may be primarily generated in the first and second trenches 751 and 752, and after that, the discharge spreads over the entire region of the discharge cell 714. Due to a strong electric field generated in the first and second trenches 751 and 752, the discharge may be generated by using a low voltage. Therefore, it is possible to reduce a discharge voltage. In addition, due to predetermined voltages applied to the first and second grid electrodes 731a and 731b, the electrons accelerated from the first and second electron-emitting material layers 741a and 741b may be alternately emitted into the strong electric field of the first trench 751. In addition, due to predetermined voltages applied to the third and fourth grid electrodes 732a and 732b, the electrons accelerated from the third and fourth electron-emitting material layers 742a and 742b may be alternately emitted into the strong electric field of the second trench 752. As a result, the plasma discharge may be efficiently generated by the emitted electrons, so that it may be possible to improve brightness and luminous efficiency.

FIG. 14 is a cross sectional view of a flat lamp according to an eighth embodiment of the present disclosure. The flat lamp includes rear and front panels separated from each other in a predetermined interval. Between the rear and front panels, there may be provided at least one discharge cell 814 where plasma discharge may be generated. In addition, between the rear and front panels, there may be provided at least one spacer 813 which may support the rear and front panels and partitions the space between the rear and front panels to define the discharge cells 814. The discharge cells 814 may be filled with a discharge gas emitting ultraviolet (UV) light at the plasma discharge. Fluorescent layers 815 having a predetermined thickness may be coated on inner walls of the respective discharge cells 814.

The rear panel includes a rear substrate 810 and a plurality of pairs of first and second discharge electrodes 811a and 811b formed for the respective discharge cells 814 on a lower surface of the rear substrate 810. A first trench 851 may be provided on an upper portion of the rear substrate 810 between first and second discharge electrodes 811a and 811b. First and second electron-emitting material layers 841a and 841b having a predetermined thickness may be provided on the respective sidewalls of the first trench 851. Preferably, the first and second electron-emitting material layers 841a and 841b may be made of OPPS capable of accelerating and emitting electrons outwardly.

The front panel may include a front substrate 820 separated from the rear substrate 810 in a predetermined interval and a plurality of pairs of third and fourth discharge electrodes 821a and 821b formed for the respective discharge cells 814 on an upper surface of the front substrate 820. A second trench 852 may be provided on lower portion of the front substrate 820 between the third and fourth discharge electrodes 821a and 821b. Third and fourth electron-emitting material layers 842a and 842b having a predetermined thickness may be provided on the respective sidewalls of the second trench 852. Preferably, the third and fourth electron-emitting material layers 842a and 842b may be made of OPPS capable of accelerating and emitting electrons outwardly.

In the flat lamp according to the embodiment, when predetermined AC voltages are applied between the first and second discharge electrodes 811a and 811b and between the third and fourth discharge electrodes 821a and 821b, the discharge may be primarily generated in the first and second trenches 851 and 852, and after that, the discharge may spread over the entire region of the discharge cell 814. Due to the predetermined AC voltages applied between the first and second discharge electrodes 811a and 811b, the electrons accelerated from the first and second electron-emitting material layers 841a and 841b may be alternately emitted into the first trench 851. In addition, due to the predetermined VC voltages applied between the third and fourth discharge electrodes 821a and 821b, the electrons accelerated from the third and fourth electron-emitting material layers 842a and 842b may be alternately emitted into the second trench 852. As a result, the plasma discharge may be efficiently generated by the emitted electrons, so that it may be possible to improve brightness and luminous efficiency.

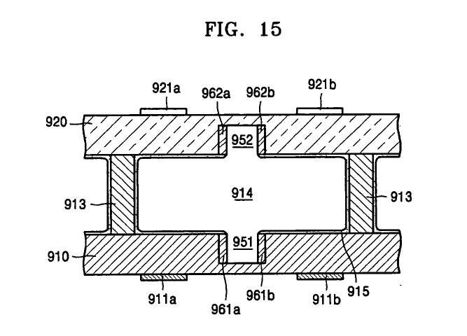

FIG. 15 is a cross sectional view of a flat lamp according to a ninth embodiment of the present disclosure. The flat lamp may include rear and front panels separated from each other in a predetermined interval. Between the rear and front panels, there may be provided at least one discharge cell 914 where plasma discharge may be generated. In addition, between the rear and front panels, there may be provided at least one spacer 913 which supports the rear and front panels and partitions the space between the rear and front panels to define the discharge cells 914. The discharge cells 914 may be filled with a discharge gas emitting ultraviolet (UV) light at the plasma discharge. Fluorescent layers 915 having a predetermined thickness may be coated on inner walls of the respective discharge cells 914.

The rear panel may include a rear substrate 910 and a plurality of pairs of first and second discharge electrodes 911a and 911b formed for the respective discharge cells 914 on a lower surface of the rear substrate 910. A first trench 951 may be provided on an upper portion of the rear substrate 910 between first and second discharge electrodes 911a and 911b. First and second electron-emitting material layers 961a and 961b may be provided on the respective sidewalls of the first trench 951. The first and second electron-emitting material layers 961a and 961b may be made of CNT capable of emitting a large number of electrons into the first trench 951 The front panel may include a front substrate 920 separated from the rear substrate 910 in a predetermined interval and a plurality of pairs of third and fourth discharge electrodes 921a and 921b formed for the respective discharge cells 914 on an upper surface of the front substrate 920. A second trench 952 may be provided on lower portion of the front substrate 920 between the third and fourth discharge electrodes 921a and 921b. Third and fourth electron-emitting material layers 962a and 962b may be provided on the respective sidewalls of the second trench 952. Preferably, the third and fourth electron-emitting material layers 962a and 962b are made of CNT capable of emitting a large number of electrons into the second trench 952.

In the flat lamp according to the embodiment, when predetermined AC voltages are applied between the first and second discharge electrodes 911a and 911b and between the third and fourth discharge electrodes 921a and 921b, the discharge may be primarily generated in the first and second trenches 951 and 952, and after that, the discharge may spread over the entire region of the discharge cell 914. Due to the predetermined AC voltages applied between the first and second discharge electrodes 911a and 911b, a large number of the electrons emitted from the first and second electron-emitting material layers 961a and 961b may be alternately accelerated into the first trench 951. In addition, due to the predetermined VC voltages applied between the third and fourth discharge electrodes 921a and 921b, a large number of the electrons emitted from the third and fourth electron-emitting material layers 962a and 962b may be alternately accelerated into the second trench 952. As a result, the plasma discharge may be efficiently generated by the accelerated electrons, so that it is possible to improve brightness and luminous efficiency.

In the flat lamps of the aforementioned embodiments, a pair of discharge electrodes may be provided to both of the rear and front substrates. However, not limited thereto, the discharge electrodes may be one of the rear and front substrate.

A trench may be provided between a pair of discharge electrodes, so that it may be possible to concentrate an electric field on an inner portion of the trench. Therefore, discharge may be generated by using a low voltage, so that it may be possible to reduce a discharge voltage. In addition, there may be provided an electron-emitting material layer capable of emitting accelerated electrons or a large number of electrons into a strong electric field of the trench, so that the plasma discharge may be efficiently generated. Therefore, it may be possible to improve brightness and luminous efficiency.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A plasma-discharge light emitting device comprising:
rear and front panels separated from each other in a predetermined interval, wherein at least one discharge cell is provided between the rear and front panels, and wherein plasma discharge is generated in the discharge cells;
a pair of discharge electrodes provided on at least one of the rear and front panels for each of the discharge cells;
a trench provided as a portion of each of the discharge cells between the pair of the discharge electrodes; and
electron-emitting material layers provided on both sidewalls of the trench.

2. The plasma-discharge light emitting device according to claim 1, wherein the electron-emitting material layers comprise OPPS (oxidized porous polysilicon).

3. The plasma-discharge light emitting device according to claim 2, further comprising grid electrodes provided on the electron-emitting material layers.

4. The plasma-discharge light emitting device according to claim 1, wherein the electron-emitting material layers comprise CNT (carbon nanotube).

5. A plasma display panel comprising:
rear and front substrate separated from each other in a predetermined interval, wherein a plurality of discharge cells are provided between the rear and front substrates, and wherein plasma discharge is generated in the discharge cells;
a plurality of barrier ribs provided between the rear and front substrates to partition a space between the rear and front substrates and define the discharge cells;
a plurality of address electrodes provided on an upper surface of the rear substrate;
a first dielectric layer provided on the upper surface of the rear substrate to bury the address electrodes;
a pair of sustain electrodes provided on a lower surface of the front substrate for each of the discharge cells;
a second dielectric layer provided on the lower surface of the front substrate to bury the sustain electrode, wherein a trench is provided as a portion of each of the discharge cells between the pair of the sustain electrodes;
electron-emitting material layers provided on both sidewalls of the trench; and
a fluorescent layer formed on an inner wall of each of the discharge cells.

6. The plasma display panel according to claim 5, wherein the trench is parallel to the sustain electrodes.

7. The plasma display panel according to claim 5, wherein each of the electron-emitting material layer comprises OPPS (oxidized porous polysilicon).

8. The plasma display panel according to claim 7, further comprising grid electrodes provided on the respective electron-emitting material layers.

9. The plasma display panel according to claim 8, wherein the sustain electrode is disposed adjacent to the electron-emitting material, and wherein the electron-emitting material and the grid electrode face each other.

10. The plasma display panel according to claim 5, wherein the electron-emitting material layers comprise CNT (carbon nanotube).

11. The plasma display panel according to claim 5, further comprising bus electrodes provided on lower surfaces of the respective sustains electrodes.

12. The plasma display panel according to claim 5, further comprising a protective layer provided on the second dielectric layer.

13. A flat lamp comprising:
rear and front substrate separated from each other in a predetermined interval, wherein at least one discharge cell is provided between the rear and front substrates, and wherein plasma discharge is generated in the discharge cells;
a pair of discharge electrodes provided on an inner surface of at least one of the rear and front substrates for each of the discharge cells;
a dielectric layer provided on the inner surface of each of the substrates where the discharge electrodes are provided, wherein the dielectric layer buries the discharge electrodes, wherein a trench is provided as a portion of each of each of the discharge cells between the pair of the discharge electrodes;
electron-emitting material layers provided on both of sidewalls of the trench; and
a fluorescent layer formed on an inner wall of each of the discharge cells.

14. The flat lamp according to claim 13, wherein the trench is parallel to the discharge electrodes.

15. The flat lamp according to claim 13, wherein the electron-emitting material layers comprise OPPS (oxidized porous polysilicon).

16. The flat lamp according to claim 15, further comprising grid electrodes provided on the respective electron-emitting material layers.

17. The flat lamp according to claim 16, wherein each of the discharge electrodes is disposed adjacent to the electron-emitting material, and wherein the electron-emitting material and the grid electrode face each other.

18. The flat lamp according to claim 13, wherein the electron-emitting material layers comprise CNT (carbon nanotube).

19. The flat lamp according to claim 13, further comprising at least one spacer, wherein the spacers partition a space between the rear and front substrates to define the discharge cells.

20. A flat lamp comprising:
rear and front substrate separated from each other in a predetermined interval, wherein at least one discharge cell is provided between the rear and front substrates, and wherein plasma discharge is generated in the discharge cells;
a pair of discharge electrodes provided on an outer surface of at least one of the rear and front substrates for each of the discharge cells;
a trench provided as a portion of each of the discharge cells on an inner portion of the substrate between the pair of the discharge electrodes;
electron-emitting material layers provided on both sidewalls of the trench; and
a fluorescent layer formed on an inner wall of each of the discharge cells.

21. The flat lamp according to claim 20, wherein the trench is parallel to the discharge electrodes.

22. The flat lamp according to claim 20, wherein the electron-emitting material layers comprise OPPS (oxidized porous polysilicon).

23. The flat lamp according to claim 22, further comprising grid electrodes provided on the respective electron-emitting material layers.

24. The flat lamp according to claim 20, wherein the-electron-emitting material layers comprise CNT (carbon nanotube).

25. The flat lamp according to claim 20, further comprising at least one spacer, wherein the spacers partition a space between the rear and front substrates to define the discharge cells.
